(19) United States
(12) Patent Application Publication
(10) Pub. No.: US 2009/0199772 A1
(43) Pub. Date: Aug. 13, 2009

(54) SQUIRREL PROOF PLATFORM BIRD FEEDER

(76) Inventor: Robert A. George, Broadalbin, NY (US)

Correspondence Address: SCHMEISER, OLSEN & WATTS, 22 CENTURY HILL DRIVE, SUITE 302, LATHAM, NY, 12110, US

(21) Appl. No.: 12/367,169

(22) Filed: Feb. 6, 2009

Related U.S. Application Data
(60) Provisional application No. 61/027,091, filed on Feb. 8, 2008.

(51) Int. Cl. A01K 39/01

(52) U.S. Cl. 119/52.3; 119/61.5

(57) ABSTRACT

Disclosed herein is a squirrel proof feeder which includes a dispenser bowl configured to hold feed and a cage surrounding the dispenser bowl having two barrier rings separated by a vertical spacing. Furthermore, each separated from the dispenser bowl by a lateral spacing, wherein the lateral spacing and the vertical spacing are configured to prevent the squirrel from obtaining feed from the dispenser bowl.

### RELATED MATTER

This application is a non-provisional claiming priority to a commonly owned U.S. Provisional Patent Application Ser. No. 61/027,091, filed Feb. 8, 2008, of Robert A. George, entitled “SQUIRREL PROOF PLATFORM BIRD FEEDER,” the disclosure of which is herein incorporated by reference to the extent not inconsistent with the present disclosure.

### BACKGROUND

Birdwatching or birding is the observation and study of birds with the naked eye or through a visual enhancement device like binoculars. Most birders and birdwatchers pursue this activity for recreational or social reasons, unlike ornithologists, who are engaged in the formal scientific study of birds. Feeding birds is one technique to attract birds of a particular species for birdwatching or birding. However, conventional birdfeeders have several problems associated with their use.

It is often the case that squirrels and other nuisances, such as grackles or larger birds consume the food intended for the smaller birds. Squirrels, for example, are generally clever and persistent animals. They are notorious for eating out of bird feeders which becomes a nuisance to a birdwatcher or birder. Furthermore, the presence of squirrels often scares away the birds. This problem becomes more difficult in that not all squirrels are of the same size and may require unique solutions for different types of squirrels. Common squirrels include the Fox squirrel; the Western Gray Squirrel; the Douglas Squirrel; the American Red Squirrel; and the Eastern Grey Squirrel. The Red Squirrel has a typical head-and-body length of 19 to 23 cm (7.5 to 9 in), a tail length of 15 to 20 cm (5.9 to 7.9 in) and a mass of 250 to 340 g (8.8 to 12 oz). The Red Squirrel is anatomically smaller than the Eastern Grey Squirrel which has a head-and-body length of 25 to 30 cm and weighs between 400 and 800 g (14 oz to 1.8 lb).

Thus, an apparatus which prevents nuisances from feeding on the seed while still allowing the birds access and provides other advantages would be well received in the art.

### SUMMARY OF THE INVENTION

According to one aspect of the invention, a squirrel proof feeder comprises a dispenser bowl configured to hold feed and a cage surrounding the dispenser bowl having two barrier rings separated by a vertical spacing and each separated from the dispenser bowl by a lateral spacing, wherein the lateral spacing and the vertical spacing are configured to prevent the squirrel from obtaining feed from the dispenser bowl.

According to another aspect of the invention, a bird feeder comprises a dispenser bowl configured to hold feed, a feed reservoir configured to dispense feed into the dispenser bowl, a connector flange located about the feed reservoir and a removable grackle guard, the grackle guard surrounding the squirrel proof feeder, the bottom of the grackle guard positioned 1 to 1½ inches above the bottom of the dispenser bowl, the grackle guard slidable over the feed reservoir and the flange, and grackle guard attachable to and detachable from the connector flange.

According to another aspect of the invention, a bird feeder comprises a dispenser bowl configured to hold feed and a rotatable sweeping bar attached to the center of the dispenser bowl, the rotatable sweeping bar extending along the base and wall of the dispenser bowl, the rotatable sweeping bar configured to rotate about the center of the dispenser bowl and sweep residue from the bottom of the dispenser bowl.

According to yet another aspect of the present invention, a bird feeder comprises a dispenser bowl configured to hold feed, and a center ring opening extending from the bottom of a feed reservoir configured to dispense feed into the dispenser bowl, the center ring opening including a plurality of semi-circular openings, each opening extending from the bottom edge of the center ring.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of a squirrel-proof bird feeder in accordance with one embodiment of the present invention;

FIG. 2 depicts a perspective view of a squirrel-proof bird feeder having a grackle guard in accordance with one embodiment of the present invention.

FIG. 3 depicts a perspective view of a dispenser and a bowl of the squirrel-proof bird feeder having a semi-circular distribution element in accordance with one embodiment of the present invention;

FIG. 4 depicts a perspective view of a dispenser and a bowl of the squirrel-proof bird feeder having a semi-circular distribution element and a rotatable sweep bar in accordance with one embodiment of the present invention;

FIG. 5 depicts a side cutaway view of the bowl of FIG. 2 in accordance with one embodiment of the present invention;

FIG. 6 depicts a side cutaway view of a bowl having a square distribution element in accordance with one embodiment of the present invention;

FIG. 7 depicts a side cutaway view of a bowl having a rectangular distribution element in accordance with one embodiment of the present invention;

FIG. 8 depicts a side cutaway view of a bowl having a semi-circular distribution element in accordance with one embodiment of the present invention;

FIG. 9 depicts a perspective view of a feed reservoir in accordance with one embodiment of the present invention; and

FIG. 10 depicts perspective view of the cover with a handle removed from the feeder in accordance with one embodiment of the present invention.

### DETAILED DESCRIPTION OF THE INVENTION

A detailed description of the hereinafter described embodiments of the disclosed apparatus and method are presented herein by way of exemplification and not limitation with reference to the Figures.

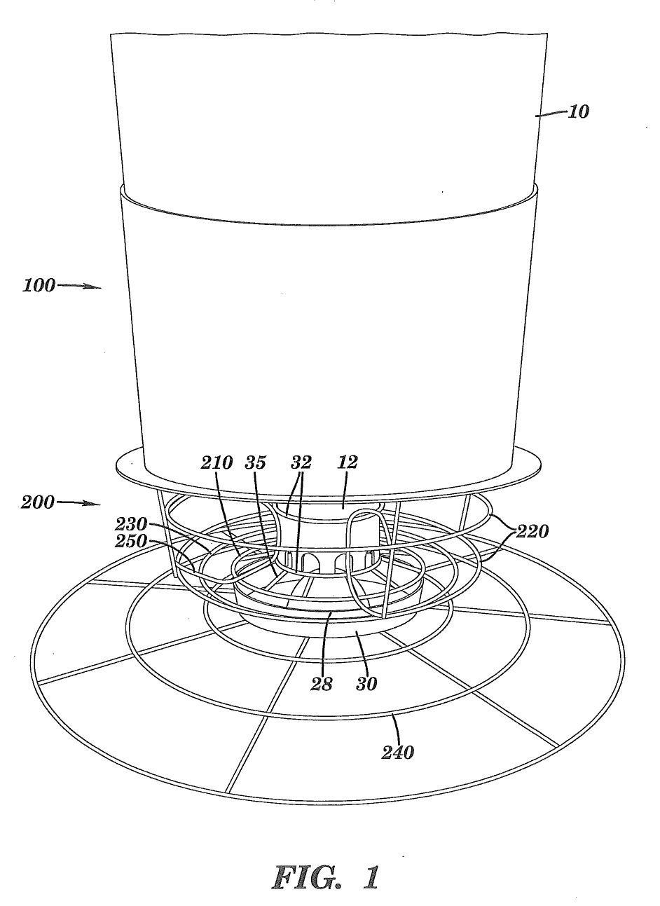

Referring firstly to FIG. 1, a perspective view of a squirrel-proof bird feeder 100 is shown in accordance with one embodiment of the present invention. The squirrel-proof feeder 100 comprises a food storage reservoir 10 configured to dispense feed into a dispenser bowl 30. The dispenser bowl 30 is positioned beneath the food storage reservoir 10 so that the feed enters the dispenser bowl 30 through an opening 12 in the bottom of the food storage reservoir 10. The squirrel-proof feeder also includes a perch platform 240 and a guard 260. Furthermore, a cage 200 surrounds the dispenser bowl 30, including two vertically spaced semi-parallel barrier rings 220 and a blocking bar 230. The cage 200 is dimensioned and configured to prevent a squirrel from obtaining feed out of the dispenser bowl 30. The cage 200 is made of a material such as metal or a very hard plastic in order to prevent a squirrel from chewing through.

Describing the cage 200 in greater detail, the two vertically spaced semi-parallel barrier rings 220 are shown surrounding the feed area about ½ to 1 inch laterally from a lip 28 of the dispenser bowl 30. The barrier rings 220 are thereby shown having a diameter 1 to 2 inches greater than the diameter of the lip 28 of the dispenser bowl 30. The barrier rings 220 may be dimensioned to prevent entry of a grey squirrel, a red squirrel, or both. For example, a vertical spacing between 11/16 of an inch to 15/16 of an inch would prevent the head of a red squirrel from reaching through the cage and into the dispenser bowl 30. On the other hand, if only a grey squirrel was required to be blocked, a maximum vertical spacing of 1⅜ to 1½ inches may be used because of their larger anatomical features. This spacing still allows the smaller heads of birds to reach in. On the other hand, a squirrel has its mouth on the bottom of its head. Thus, the lower of the barrier rings 220 is configured to press against the mouth of a squirrel as it tries to insert its head between the barrier rings 220 thereby prevented it from using its mouth to access the feed. Furthermore, the lower of the two barrier rings is shown surrounding the dispenser bowl at a vertical height that is equal to or greater than the maximum height of the dispenser bowl.

The cage 200 is also shown having a blocking bar 230 that is substantially concentric with the dispensing bowl 30 and the barrier rings 220. The blocking bar 230 is located vertically beneath the lower of the parallel barrier rings 220, and has a circumference between that of the parallel barrier rings 220 and the lip 28 of the dispenser bowl 30. The blocking bar 230 is configured to prevent the reaching by a squirrel with a paw into the bowl 30 to scrape the feed out.

The cage 200 may further include a vertical alignment ring 250. The vertical alignment ring 250 may connect the cage 200 with the dispenser bowl 30. As shown in FIG. 1, the squirrel-proof bird feeder may include a plurality of vertical alignment rings 250. The vertical alignment rings 250 may help to retain the alignment between the elements of the cage 200 and prevent a squirrel from bending the cage by forcing a head between the bars.

Referring still to FIG. 1, the squirrel-proof bird feeder 100 is shown to further include a perch platform 240. The perch platform is shown connected at the bottom of the dispensing bowl 30. Thus, the perch platform 240 is configured to support the dispensing bowl 30 and further support the weight of birds perching on the platform 240. Furthermore, the perch platform 240 is shown as a series of concentric wires having different circumferences, and connected by several radial wires extending from the center of the platform 240. The perch platform 240 thus contains a plurality of large openings between the wires. It is thereby is configured to let any dropped seeds fall unhindered to the ground. This serves to confuse the squirrel as to the location of where the feed is coming from. The perch platform is not limited to this concentrically ringed embodiment, however. Additionally, the perch platform 240, like the cage 200, may be made of a durable metal, hard plastic or the like in order to prevent a squirrel from chewing through.

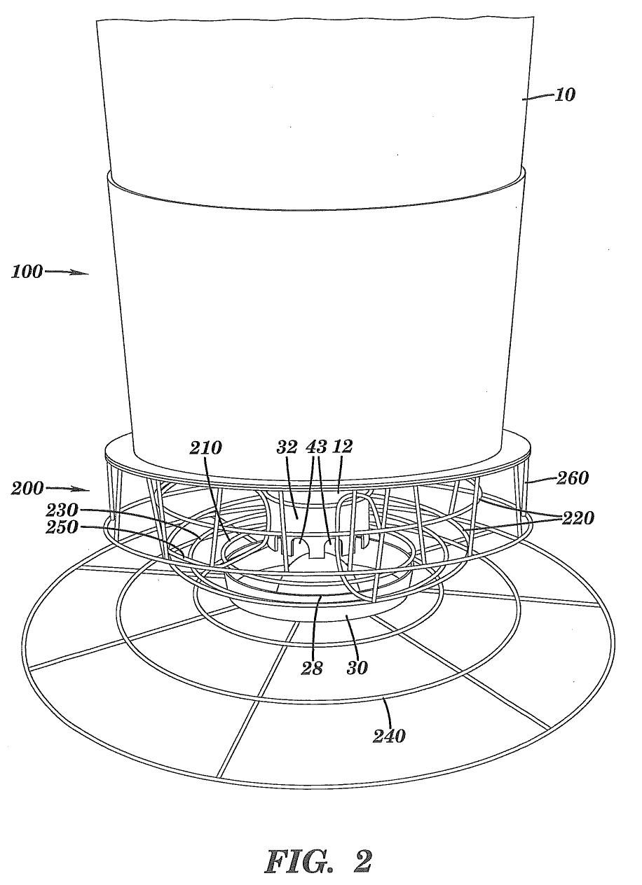

Furthermore, shown in FIG. 2, the squirrel-proof bird feeder 100 may also include a guard 260 positioned around and above the cage 200. This guard 260 is positioned between 2 and 4 inches above the platform perch 240. Preferably, the grackle guard 260 is positioned between 3 and 3½ inches above the platform perch 240. The guard 260 is configured to prevent larger birds, such as grackles, from having undesired access to feed. However, the grackle guard 260 is not required and may be removed or otherwise disabled when a user desires to allow larger birds to have access to the feed.

The grackle guard 260 may be attachable via an interface with a bottom flange of the food storage reservoir 10. In one embodiment, the grackle guard 260 is slipped over the food storage reservoir 10, which designedly may have a smaller circumference than the guard 260. The guard 260 may include interfacing wires which slip through openings in the flange of the food storage reservoir 10. Other than the interfacing wires of the grackle guard 260, the rest of the guard 260 may have a larger circumference than the flange of the food storage reservoir 10. The guard 260 may then be rotated, during which the interfacing wires of the grackle guard 260 may slip into an interfacing receiver of the flange of the food storage reservoir 10. The attachment and removal is not limited to this embodiment, however, and may include any attachment or removal technique that is known to those skilled in the art. Furthermore, the grackle guard 260 may be attachable so that the wire mesh is above the flange of the food storage reservoir. In other words, the grackle guard 260 may be attachable to the flange upside down from how it is attached in FIG. 2. In this embodiment, the grackle guard 260 may be used as an additional perch.

The grackle guard 260 may be a plastic ring having an ornamental design, or may simply be a wired mesh, as shown in FIG. 2. In any case, the grackle guard 260 may be made of a resistant material that cannot be chewed through by birds, squirrels or other animals. The grackle guard 260 may be configured to either fill the gap between the flange and the barrier rings 220. Alternately, the grackle guard 260 may have a larger circumference than the barrier rings 220, and the lowest point of the grackle guard 260 may extend lower than the height of the top barrier ring 220. However, as shown in FIG. 2, the grackle guard 260 may extend to about the level of the height of the top barrier ring 220.

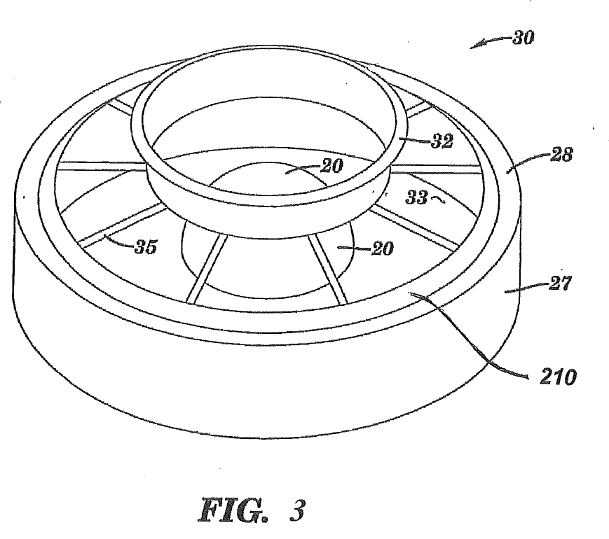

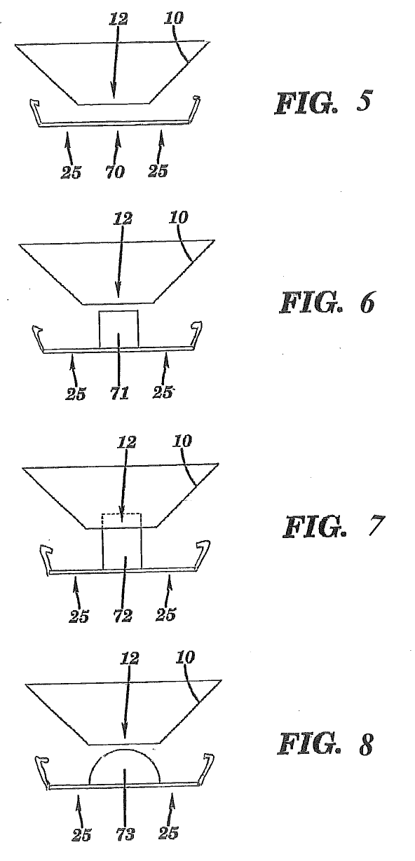

Referring now to FIG. 3, a perspective view of the dispenser bowl 30 is shown having a semi-circular distribution element 20, in accordance with one embodiment of the present invention. The distribution element 20 is located on a base 25 of the dispenser bowl 30 and is configured to adjust the flow from the feed storage reservoir 10 to the dispenser bowl 30, and distribute the feed radially outward in the bowl 30 to allow the birds to have easier access. On the other hand, as shown in FIG. 5, the bowl may not have a distribution element, but may instead be flat 70. Furthermore, as shown in FIGS. 6-8, the distribution element may be square 71, rectangular 72, or spherical 73.

Referring still to FIG. 3, the dispenser bowl 30 includes a wall 27 which may be substantially vertical, as shown, or may be angled depending on the desired shape of the bowl 30. Furthermore, the lip 28 of the bowl 30 may be inward facing to further prevent the undesired scrapping of seeds out of the bowl 30. A squirrel's claw may hook but not bend downwardly or inwardly like a human hand. The squirrel's claw can scrap seeds and pull back, but not insert a claw and lift like a human hand. Thus, when the claw pulls back, the seeds may be caught on the lip 28.

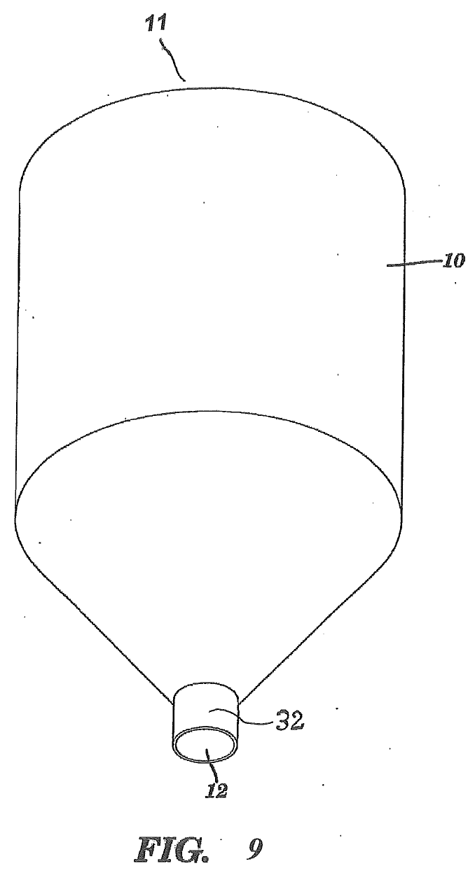

The dispenser bowl 30 may include a center ring 32, a dispenser wall ring 210 and a plurality of overflow and sweep prevention bars 35. These elements may be integrally included in the dispenser bowl 30, as shown in FIG. 2. These elements may also be integrally included as part of the cage 200, as shown in FIG. 1. Still further, the center ring 32 may be integrally included into the feed reservoir 10, as shown later in FIG. 9. Additionally, the cage 200 and the dispenser bowl 30 may be structurally connected to each other in one fashioned element. Whatever the embodiment, the center ring 32 may be configured to receive the food storage reservoir 10. The squirrel-proof bird feeder 100 may have two or more center rings 32. The center ring 32 may be a thick element as shown in FIGS. 1-4. In this embodiment the center ring 32 may include semi-circular openings 43. This opened configuration serves as a partial stopper for the feed entering the dispenser bowl 30. The openings 43 also allow the birds to pick the seed out through the openings 43, in case, for example, the feed gets stuck.

The dispenser wall ring 210 may be positioned above or substantially near the surrounding wall 27 and lip 28 of the dispenser bowl 30. The overflow and sweep prevention bars 35 may each extend radially from the center ring 32, connecting it with the dispenser wall ring 210. Spacings 35 are shown between the overflow and sweep prevention bars 35 through which birds may easily obtain the feed. The sweep prevention bars 35 may be slightly angled from the peak at the center ring 32 down to the food bowl wall ring 210, as shown in FIG. 2, and further prevent the sweeping of the paws of animals such as squirrels. Further, the overflow and sweep prevention bars 35 help to prevent the overflow of feed from the dispenser bowl 30.

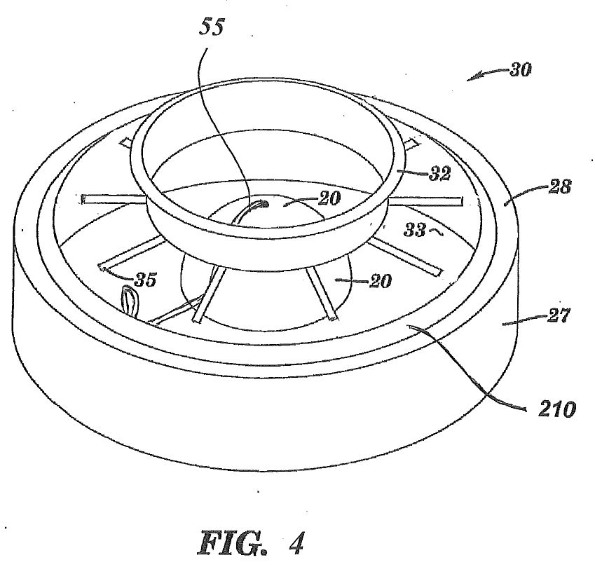

Referring now to FIG. 4, another embodiment of the bowl 30 contemplates a rotatable sweeping bar 55. The rotatable sweeping bar 55 is used to sweep the residue from the bottom of the bowl 30, in order to aid in the cleaning of the bowl 30. A bird feeder often times beings to generate residue after being left out for a long time, particularly after it rains. This residue is not desirable for birds to eat, and needs to be cleaned. However, the cage 200 provided by this invention makes cleaning more difficult. Therefore, the rotatable sweeping bar 55 may extend from the distribution element and rotate about bowl, sweeping up the residue. In this embodiment, the vertical alignment rings 250 may include a cutout in order to allow for the sweeping bar 55 to rotate 360 degrees about the center of the bowl. Additionally, embodiments having the sweeping bar 55 may or may not include the sweep prevention bars 35. In the case that the sweep prevention bars 35 are included, they may only extend from the bowl 30. There may be an opening between the sweep prevention bars 35 and the side of the bowl 30, as shown in FIG. 4.

Referring now to FIG. 9, a perspective view of a feed reservoir 10 in accordance with one embodiment of the present invention is shown. The feed reservoir 10 includes a first opening 11 configured for receiving feed and a second opening 12 configured for dispensing feed into the bowl 30. The end of the feed reservoir 10 containing the second opening 12 may be insertable into the center ring 32 of the bowl 30. Alternately, as shown in FIG. 9, the center ring 32 may be integrally included in the feed reservoir 10.

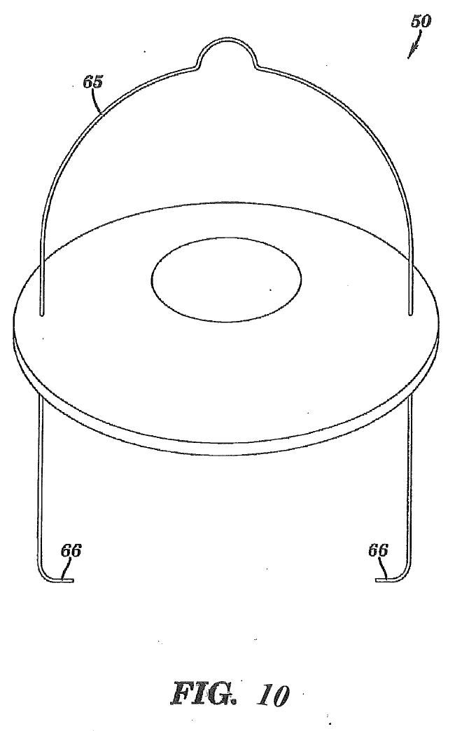

Referring lastly to FIG. 10, a lid 50 is shown. The lid 50 protects the food reservoir from unwanted entry of moisture. The lid 50 may include a handle 65, and be attachable to the squirrel-proof bird feeder 100 at endpoints 66. The lid 50 may be removable so that, for example, the grackle guard 260 may be slid over the feed reservoir 10.

Although the features of the invention (such as the barrier rings 220, the dispensing bowl 30, and the blocking bar 230) have been described geometrically as rings in accordance with the embodiment shown in the Figures, it should be understood that any geometrical configuration may be used so long as it meets the dimensional requirements based on the squirrel anatomy as described hereinabove. Thus, the barrier rings 220 may be square, undulated, ovoid, elliptical, hexagonal, octagonal or triangular, depending on the shape of the dispenser bowl 30. For example, the barrier rings 220 may be square, with each side being between 1 to 2 inches greater in length than the length of a side of a square dispenser bowl 30 (not shown).

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A squirrel proof feeder comprising:
a dispenser bowl configured to hold feed; and
a cage surrounding the dispenser bowl having two barrier rings separated by a vertical spacing and each separated from the dispenser bowl by a lateral spacing, wherein the lateral spacing and the vertical spacing are configured to prevent the squirrel from obtaining feed from the dispenser bowl.

2. The squirrel proof feeder of claim 1, further comprising a blocking bar surrounding the dispenser bowl, and located between the dispenser bowl and the lower of the two barrier rings, wherein the blocking bar is configured to prevent a squirrel from scraping the feed with a paw.

3. The squirrel proof feeder of claim 1, wherein the vertical spacing is between 11/16 of an inch to 1½ inches.

4. The squirrel proof feeder of claim 1, wherein the lateral spacing is between ½ of an inch to 1 inch.

5. The squirrel proof feeder of claim 1, wherein the dispenser bowl includes an inward lip that is configured to prevent a squirrel from scraping the feed from the bowl 30.

6. The squirrel proof feeder of claim 1, further including a grackle guard surrounding the squirrel proof feeder and positioned above the cage and 1 to 1½ inches above the bottom of the dispenser bowl.

7. The squirrel proof feeder of claim 1, further including a food storage reservoir having a first opening configured to accept feed and a second opening configured to dispense feed into the dispensing bowl.

8. The squirrel proof feeder of claim 7, wherein the dispenser bowl further includes a distribution element configured to adjust the flow from the second opening radially outward in the bowl.

9. The squirrel proof feeder of claim 1, wherein the lower of the two barrier rings surrounds the dispenser bowl at a vertical height that is equal to or greater than the maximum height of the dispenser bowl.

10. The squirrel proof feeder of claim 1, further including a perch platform located beneath and radially outward from the dispenser bowl and configured to support the weight of birds perching, the perch platform including a plurality of openings, the openings configured to allow dropped feed to fall through the perch platform.

11. The squirrel proof feeder of claim 10, wherein the perch platform further comprises:
a plurality of concentric wires extending from the center of the platform; and
a plurality of radially outward wires crossing the plurality of concentric wires and connecting the plurality of concentric wires.

12. The squirrel proof feeder of claim 1, further comprising:
a removable lid positionable over the first opening of the food reservoir to prevent contamination of the feed; and
a handle attached to the food reservoir.

13. The squirrel proof feeder of claim 1, further comprising a center ring opening extending from the bottom of a feed reservoir configured to dispense feed into the dispenser bowl, the center ring opening including a plurality of semi-circular openings, each opening extending from the bottom edge of the center ring.

14. The squirrel proof feeder of claim 1, further comprising a rotatable sweeping bar attached to the center of the dispenser bowl, the rotatable sweeping bar extending along the base and wall of the dispenser bowl, the rotatable sweeping bar configured to rotate about the center of the dispenser bowl and sweep residue from the bottom of the dispenser bowl.

15. The squirrel proof feeder of claim 14, wherein the cage further comprises a dispenser wall ring positioned above a surrounding lip of the dispenser.

16. The squirrel proof feeder of claim 16, wherein the cage further comprises a vertical alignment ring connecting at least one of the barrier rings with at least one of the center opening ring and the dispenser wall ring.

17. The squirrel proof feeder of claim 1, wherein the cage is a metal wire cage.

18. A bird feeder comprising:
a dispenser bowl configured to hold feed;
a feed reservoir configured to dispense feed into the dispenser bowl;
a connector flange located about the feed reservoir; and
a removable grackle guard, the grackle guard surrounding the squirrel proof feeder, the bottom of the grackle guard positioned 1 to 1½ inches above the bottom of the dispenser bowl, the grackle guard slidable over the feed reservoir and the flange, and grackle guard attachable to and detachable from the connector flange.

19. A bird feeder comprising:
a dispenser bowl configured to hold feed; and
a rotatable sweeping bar attached to the center of the dispenser bowl, the rotatable sweeping bar extending along the base and wall of the dispenser bowl, the rotatable sweeping bar configured to rotate about the center of the dispenser bowl and sweep residue from the bottom of the dispenser bowl.

20. A bird feeder comprising:
a dispenser bowl configured to hold feed; and
a center ring opening extending from the bottom of a feed reservoir configured to dispense feed into the dispenser bowl, the center ring opening including a plurality of semi-circular openings, each opening extending from the bottom edge of the center ring.
